(19) United States
(12) Patent Application Publication
(10) Pub. No.: US 2013/0105720 A1
(43) Pub. Date: May 2, 2013

(54) Electro-Mechanical Three-Way Dual Seat Valve

(71) Applicant: Keith R. Kabel, Shelby Township, MI (US)

(72) Inventor: Keith R. Kabel, Shelby Township, MI (US)

(73) Assignee: GM GLOBAL TECHNOLOGY OPERATIONS LLC, Detroit, MI (US)

(21) Appl. No.: 13/286,452

(22) Filed: Nov. 1, 2011

(51) Int. Cl. F16K 3/30

(52) U.S. Cl. 251/328

(57) ABSTRACT

A three-way dual seat valve having a valve body including mutually spaced apart annular first and second valve seats. Reciprocally mounted with respect to the valve body is a valve stem which carries within the valve body an annular, dual-faced valve stem gate. Each gate face thereof is sealingly engageable with a respective valve seat in response to reciprocal movement of the valve stem.

### TECHNICAL FIELD

The present invention relates to valves, including coolant valves typically used in automotive applications. More particularly, the present invention relates to a reciprocating, three-way dual seat valve.

### BACKGROUND OF THE INVENTION

Valves are ubiquitous in fluid flow systems to provide directional control of the fluid flow therewithin. Valves are used to open and close fluid flow directions, wherein the valve may function between a fully open and fully closed state, or may be progressive, wherein the state of opening is selectively somewhere therebetween so as to meter fluid flow. Valves may be two-way, controlling fluid flow with respect to an inlet and an outlet of the valve, or may be three-way, controlling fluid flow with respect to a pair of inlets and a single outlet of the valve or a pair of outlets and a single inlet of the valve.

Valve sealing is important, and common strategy for sealing is with a face seal against a ball, cylinder, or sleeve. The seals wear due to frictional forces and scrub due to contamination and deposition. Some of these seals need tight tolerances based on their application which can result in high scrap rates. In automotive applications, cold coolant and ambient air temperature tends to require high forces to actuate the valve. Short life and premature leakage are the major issues on this style of valve.

Needle and seat solenoid valves have high pressure drops and excessive energy consumption. Some recent valve designs of this kind utilize a “move and stop” movement versus a “move and hold” movement in order to reduce energy consumption. Pressure drop and energy consumption are the major detriments with this style of valve.

With current valve technology in mind, what is needed is a valve which minimizes the seal surface, reduces or eliminates seal leakage and seal wear for the life of the valve, utilizes hydraulic forces innate to the fluid system to minimize energy consumption to effect tight sealing, provides a high fluid flow coefficient, and has the further ability to meter fluid flow.

### SUMMARY OF THE INVENTION

The present invention is a three-way dual seat valve which minimizes the seal surface, reduces or eliminates seal leakage and seal wear for the life of the valve, utilizes hydraulic forces innate to the fluid system to minimize energy consumption to effect tight sealing, provides a high fluid flow coefficient, and has the further ability to meter fluid flow. Accordingly, the three-way dual seat valve of the present invention has a particularly advantageous application to automotive coolant systems.

The three-way dual seat valve according to the present invention has a valve body including mutually spaced apart annular first and second valve seats. Reciprocally mounted with respect to the valve body is a valve stem which carries within the valve body an annular, dual-faced valve stem gate. Each gate face thereof is sealingly engageable (that is, seatable) with a respective valve seat in response to reciprocal movement of the valve stem. In a preferred environment of use, an inlet of the valve body is disposed between the first and second valve seats, a first outlet of the valve body is disposed downstream of the first valve seat, and a second outlet of the valve body is disposed downstream of the second valve seat; however, the outlet-inlet arrangement may be otherwise.

The valve stem is, for example, reciprocated by operation of a linear actuator in response, for example, to electronic programming and sensed data available to an electronic control module. When the valve stem gate is centrally disposed with respect to the inlet, fluid flows to both the first and second outlets, however as the valve stem gate is moved so as to approach one or the other of the valve seats, fluid flow becomes restricted at the approached valve seat to the outlet respectively thereat, whereby proportional fluid flow may be established if the valve stem gate is held separated at a selected separation distance from the approached valve seat. When the valve stem gate is seated at either of the first and second valve seats, the engaging gate face thereof sealingly abuts the valve seat, assisted by hydraulic pressure (when present) of the fluid, whereby fluid flow is prevented from passing through the now closed valve seat and only passes through the other, open, valve seat and its respective outlet. Upon movement of the valve stem in the opposite direction, the sealing of the other valve seat is effected by sealing abutment with the other gate face of the valve stem gate, and fluid flow is then possible only through the respectively other of the outlets.

As the gate face of the valve stem gate separates from its respective valve seat fluid flow therepast will be relatively rapid, depending upon fluid pressure, due to the small annular separation distance between the valve seat and the valve stem gate, whereby any debris disposed thereat will be flushed away by the rushing fluid. Additionally, the diameter of the valve stem gate is preferably less than the diameter of valve body between the first and second valve seats, whereby the valve stem gate will not scrape the valve body during reciprocation, only sealing at a beveled (or tapered) surface which defines the valve seats.

Accordingly, it is an object of the present invention to provide a three-way dual seat valve which minimizes the seal surface, reduces or eliminates seal leakage and seal wear for the life of the valve, utilizes hydraulic forces innate to the fluid system to minimize energy consumption during operation of the valve, provides a high fluid flow coefficient, and has the further ability to meter fluid flow.

This and additional objects, features and advantages of the present invention will become clearer from the following specification of a preferred embodiment.

### BRIEF DESCRIPTION OF THE DRAWINGS

FIG. 1 is a partly sectional side view of a three-way dual seat valve according to the present invention, showing an electro-magnetic actuation system therefor, further showing a valve stem gate thereof at a neutral position with respect to first and second valve seats, and yet further showing an interface of the three-way dual seat valve with a fluid flow system depicted in phantom.

FIG. 2 is a sectional view, seen along line 2-2 of FIG. 1.

FIG. 3 is a sectional view, seen along line 3-3 of FIG. 1.

FIG. 4 is a sectional view of the three-way dual seat valve of FIG. 1, wherein now the valve stem gate is seated at the first valve seat.

FIG. 5 is a sectional view, seen along line 5-5 of FIG. 4.

FIG. 6 is a sectional view, seen along line 6-6 of FIG. 4.

FIG. 7 is a sectional view of the three-way dual seat valve of FIG. 1, wherein now the valve stem gate is seated at the second valve seat.

FIG. 8 is a sectional view of the three-way dual seat valve of FIG. 1, wherein now the valve stem gate is separated a small distance from the second valve seat.

FIG. 9 is a sectional view, seen along line 9-9 of FIG. 8.

FIG. 10 is a sectional view of a three-way dual seat valve similar to FIG. 1, wherein now the first and second valve seats (rather than the stem gate) are provided a valve seal.

FIG. 11 is a sectional view of a three-way dual seat valve similar to FIG. 1, wherein now the first and second valve seats and the valve gate are provided with a valve seal.

FIG. 12 is a sectional view of a three-way dual seat valve similar to FIG. 1, wherein now none of the first and second valve seats and the valve gate are provided with a valve seal.

### DESCRIPTION OF THE PREFERRED EMBODIMENT

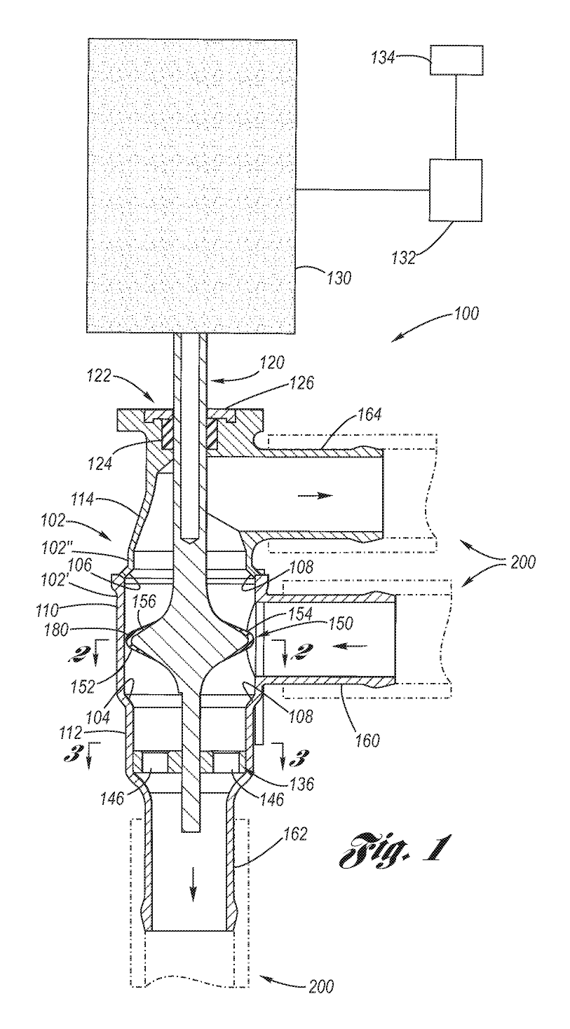

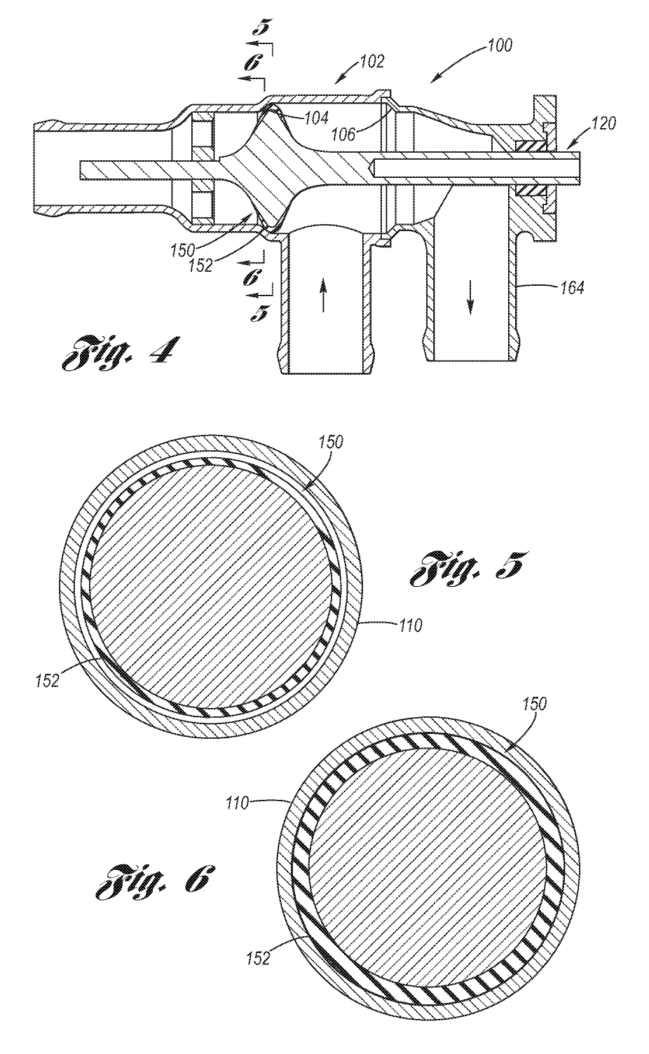

Referring now to the Drawings, FIGS. 1 through 12 depict various exemplary aspects of the structure and function of a three-way dual seat valve according to the present invention.

Referring firstly to FIGS. 1 through 9, a three-way dual seat valve 100 according to the present invention will be detailed.

The three-way dual seat valve according to the present invention includes a valve body 102 which, for purposes of manufacture, is composed of first and second valve body members 102′, 102″ which are mutually welded, threaded or otherwise sealingly joined and mechanically affixed. Within the valve body 102 is a pair of mutually separated annular valve seats, a first valve seat 104 and a second valve seat 106, each being preferably characterized by an annular bevel or taper 108. A medial valve body portion 110 of the valve body 102 is disposed between the first and second valve seats 104, 106. A first distal valve body portion 112 of the valve body 102 is disposed adjoining the first valve seat 104 in juxtaposed relation to the medial valve body portion 110. A second distal valve body portion 114 of the valve body 102 is disposed adjoining the second valve seat 106 in juxtaposed relation to the medial valve body portion 110.

A valve stem 120 passes through the valve body 102 and exits at the second distal valve body portion 114, guided and sealed by gland 122 composed of packing 124 retained by a cap 126. The exiting portion of the valve stem 120 is connected with a linear actuator 130, most preferably an electro-magnetic actuator which is, for example, actuated in response to a signal from an electronic control module 132 having programming which reacts in a predetermined manner to data sensed by one or more sensors 134.

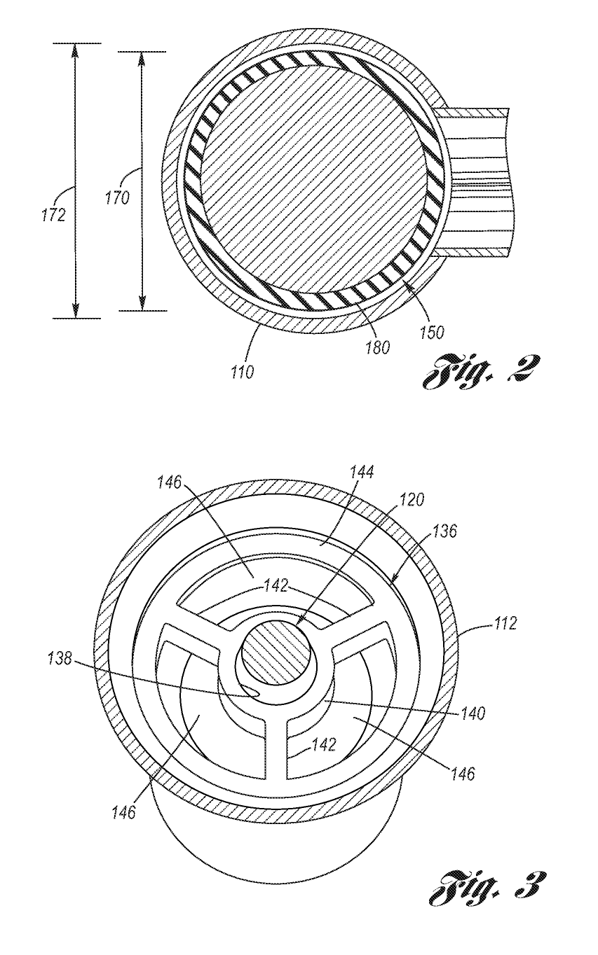

Guidance of reciprocation of the valve stem 120 in response to activation of the actuator 130 is provided additionally by a valve stem guide 136 which is attached to the first distal valve body portion 112. As best shown at FIG. 3, the valve stem 120 passes through a stem guide opening 138 which is defined by an annular stem guidance collar 140 supported by a plurality of stem guide arms 142 which connect to an annular stem guide attachment collar 144 affixed to the first distal valve body portion. The stem guide arms 142 are separated to provide a fluid flow passage 146 through the valve stem guide 136.

The valve stem 120 carries within the medial valve body portion 110 of the valve body 102 an annular, dual-faced valve stem gate 150, having a first gate face 152 which is sealingly seatable with respect to the first valve seat 104, and further having a second gate face 154 which is sealingly seatable with respect to the second valve seat 106, the seating being in response to reciprocal movement of the valve stem 120 via the actuator 130.

A first fitting 160 is connected with the valve body 102 with respect to the medial valve body portion 110, being disposed preferably centrally between the first and second valve seats 104, 106; a second fitting 162 is connected with the valve body 102 at the first distal valve body portion 112; and a third fitting 164 is connected with the valve body 102 at the second distal valve body portion 114. In the preferred environment of use of the three-way dual seat valve 100, the first fitting 160 is an inlet of a fluid flow system 200 disposed upstream of the first and second valve seats 104, 106, the second fitting 162 is an outlet of the fluid flow system disposed downstream of the first valve seat 104, and the third fitting 164 is an outlet of the fluid flow system disposed downstream of the second valve seat 106. However, the outlet-inlet assignment of the fittings may be otherwise.

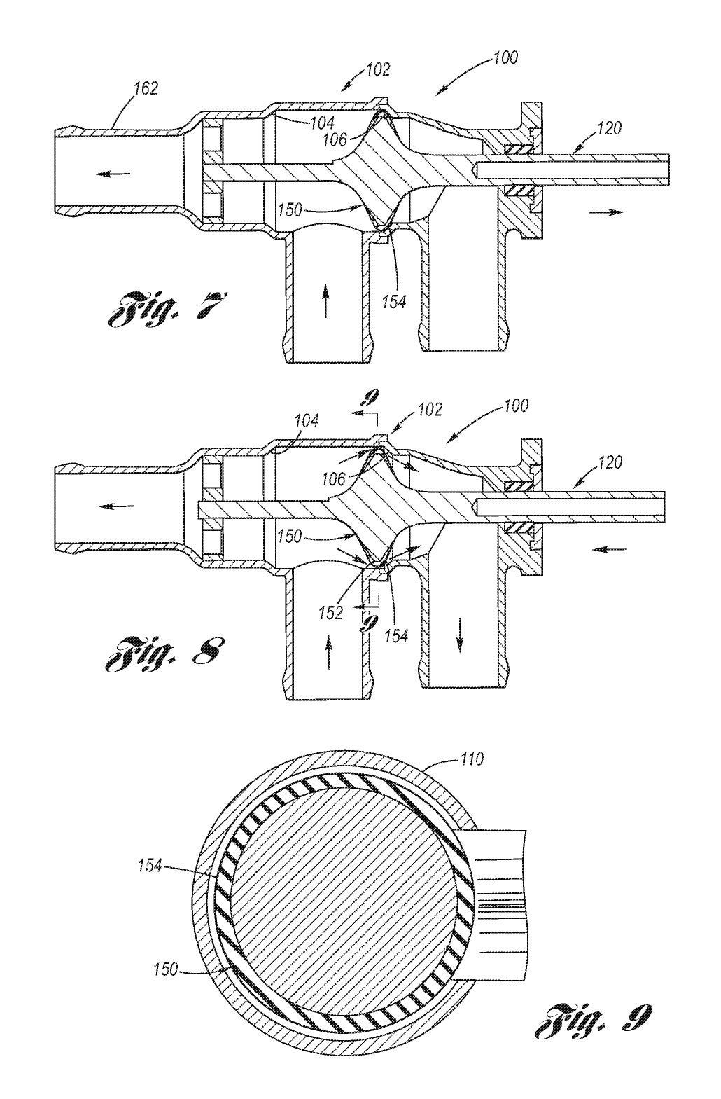

When the valve stem gate 150 is centrally disposed with respect to the first fitting 160, as shown at FIG. 1, fluid flows from the first fitting (serving as the inlet) to both of the second and third fittings 162, 164 (both serving as outlets). In response to activation of the actuator 130, the valve stem 120 reciprocates in one direction or the other and in so doing approaches one or the other of the valve seats 104, 106. As this occurs, fluid flow becomes restricted at the approached valve seat and, consequently also with respect to the outlet respectively thereat. In this manner proportional fluid flow may be established if the valve stem gate 120 is held separated at a selected separation distance from the approached valve seat 104, 106 (see FIG. 8).

When the valve stem gate is seated at either the first valve seat 104, as shown at FIG. 4, or at the second valve seat 106, as shown at FIG. 7, the respectively engaging first or second gate face 152, 154 sealingly abuts the valve seat, assisted by hydraulic pressure (when present) of the fluid. In this regard with respect to FIG. 4, fluid flow is prevented from passing through the now closed first valve seat 104 and only passes through the other, open, second valve seat 106 and its respective outlet fitting 164. Upon movement of the valve stem 120 in the opposite direction, as shown at FIG. 7, fluid flow is prevented from passing through the now closed second valve seat 106 and only passes through the other, open, first valve seat 104 and its respective outlet fitting 162.

Referring now in particular to FIG. 8, as either of the first and second gate faces 152, 154 separate from its respective valve seat 104, 106 fluid flow therepast will be relatively rapid, depending upon fluid pressure, due to the small annular separation distance between the valve seat and the valve stem gate 150, whereby any debris disposed thereat will be flushed away by the rushing fluid.

As can be appreciated by reference to FIG. 2, the outer diameter 170 of the valve stem gate 150 is preferably less than the inside diameter 172 of medial valve body portion 110. Accordingly, as can be appreciated by reference additionally to FIG. 1, the valve stem gate will not scrape the valve body 102 during reciprocation between the first and second valve seats 104, 106, only sealing at a beveling or taper 108 which defines the respective valve seat.

Additionally, the medial valve body portion 110, the first distal valve body portion 112 and the second distal valve body portion 114 are cross-sectionally sized with respect to that of the first, second and third fittings such that fluid flow has a high flow coefficient within the valve body 102. In this regard, the cross-section of the first distal valve body portion 112 is larger than the cross-section of the second fitting 162 such that the fluid flow passage 146 is cross-sectionally sized with respect to that of the second fitting such that the high coefficient of fluid flow is provided.

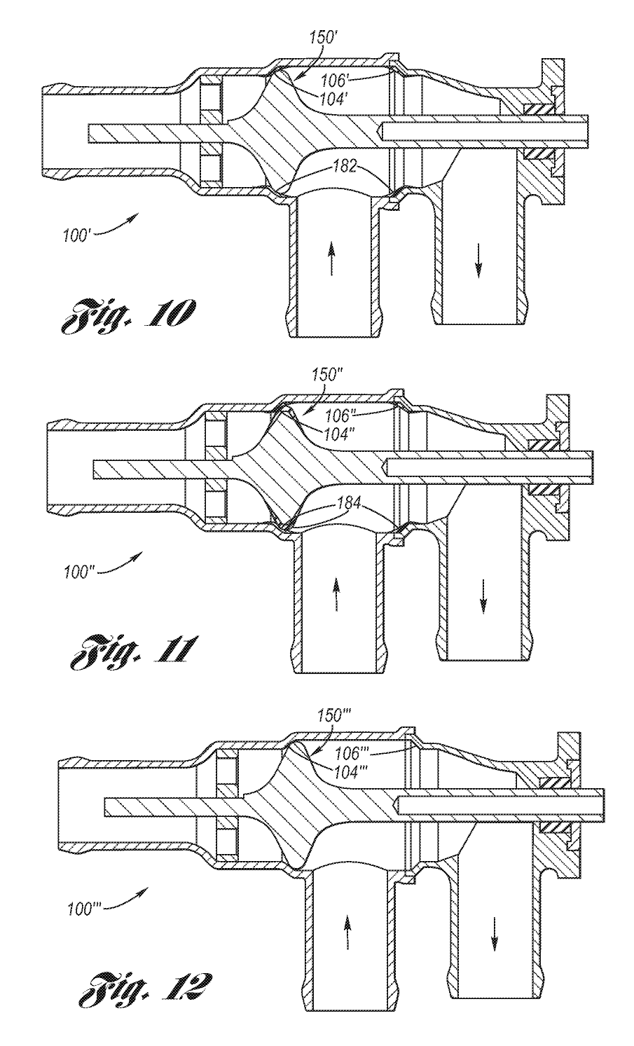

FIGS. 1 through 9 depict the three-way dual seat valve 100 according to the present invention having a valve seal 180, as for example an elastomeric material, disposed at the valve stem gate 150. In this regard the valve seal 180 is an overmold of the valve stem gate core 156 of the valve stem gate 150 jointly at the first and second gate faces 152, 154. However, as shown at FIG. 10, the three-way dual seat valve 100′ of the present invention may have a valve seal 182 disposed, preferably as an overmold, at the first and second valve seats 104′, 106′, and the valve stem gate 150′ is free of a valve seal. However further, as shown at FIG. 11, the three-way dual seat valve 100″ of the present invention may have a valve seal 184 disposed, preferably as an overmold at both the valve stem gate 150″ and the first and second valve seats 104″, 106″. Indeed, as shown at FIG. 12, the three-way dual seat valve 100′″ of the present invention may have no valve seal at both the valve stem gate 150′″ and the first and second valve seats 104′″, 106′″, wherein the valve stem gate and the first and second valve seats can be composed of similar material, or harder or softer material collectively or respectively, depending on the environment of use of the present invention.

To those skilled in the art to which this invention appertains, the above described preferred embodiment may be subject to change or modification. Such change or modification can be carried out without departing from the scope of the invention, which is intended to be limited only by the scope of the appended claims.

1. A three-way dual seat valve, comprising:
a valve body comprising a medial valve body portion, a first distal valve body portion at a first end of the medial valve body portion, and a second distal valve body portion at a second end of the medial valve body portion;
a first valve seat disposed within said valve body comprising a first generally beveled surface adjoining said medial valve body portion at said first end thereof and juxtaposed said first distal valve body portion;
a second valve seat disposed within said valve body comprising a second generally beveled surface adjoining said medial valve body portion at said second end thereof and juxtaposed said second distal valve body portion; and
a valve stem reciprocally mounted with respect to said valve body, said valve stem comprising a valve stem gate disposed in said medial valve body portion of said valve body, said valve stem gate comprising:
a first gate face configured for sealing engagement with said first valve seat when said valve stem is moved so that said valve stem gate abuts said first valve seat; and
a second gate face configured for sealing engagement with said second valve seat when said valve stem is moved so that said valve stem gate abuts said second valve seat.

2. The three-way dual seat valve of claim 1, further comprising an actuator which selectively reciprocates said valve stem gate between the sealing engagement with said first and second valve seats and to any position in said medial valve body portion disposed therebetween.

3. The three-way dual seat valve of claim 2, wherein said actuator comprises an electro-magnetic actuator.

4. The three-way dual seat valve of claim 1, further comprising,
a first fitting fluidically connected to said medial valve body portion;
a second fitting fluidically connected to said first distal valve body portion; and
a third fitting fluidically connected to said second distal valve body portion.

5. The three-way dual seat valve of claim 4, further comprising a fluid flow system connected to said first, second and third fittings, wherein the fluid flow system has a hydraulic pressure and wherein said first fitting is an inlet of the valve body in relation to the fluid flow system, and second and third fittings are outlets of the valve body in relation to the fluid flow system; and wherein:
when said first gate face sealingly engages said first valve seat the hydraulic pressure assists the sealing therebetween; and
when said second gate face sealingly engages said second valve seat the hydraulic pressure assists the sealing therebetween.

6. The three-way dual seat valve of claim 4, wherein the hydraulic pressure causes debris disposed at either of said first and second valve seats to be flushed away as said valve stem gate is moved out of sealing engagement respectively therewith.

7. The three-way dual seat valve of claim 4, further comprising a valve stem guide connected with said first distal valve body portion and guidingly interfaced with said valve stem, wherein said valve stem guide has a fluid flow passage therethrough between said medial valve body portion and said second fitting.

8. The three-way dual seat valve of claim 7, wherein said medial valve body portion, said first distal valve body portion and said second distal valve body portion are cross-sectionally sized with respect to cross-sectional sizing of said first, second and third fittings, and said fluid flow passage of said valve stem guide is cross-sectionally sized with respect to cross-sectional sizing of said second fitting such that a high coefficient of fluid flow is provided.

9. The three-way dual seat valve of claim 1, wherein said valve stem gate has an outer diameter and wherein said medial valve body portion has an inside diameter between said first and second valve seats; wherein said outside diameter exceeds said inside diameter such that said valve stem gate does not scrape said medial valve body portion during reciprocation of said valve stem.

10. The three-way dual seat valve of claim 1, wherein a valve seal is disposed on at least one of: a) said first and second gate faces, and b) said first and second valve seats.

11. A three-way dual seat valve, comprising:
a valve body comprising a medial valve body portion, a first distal valve body portion at a first end of the medial valve body portion, and a second distal valve body portion at a second end of the medial valve body portion;
a first valve seat disposed within said valve body comprising a first generally beveled surface adjoining said medial valve body portion at said first end thereof and juxtaposed said first distal valve body portion;
a second valve seat disposed within said valve body comprising a second generally beveled surface adjoining said medial valve body portion at said second end thereof and juxtaposed said second distal valve body portion;
a valve stem reciprocally mounted with respect to said valve body, said valve stem comprising a valve stem gate disposed in said medial valve body portion of said valve body, said valve stem gate comprising:
a first gate face configured for sealing engagement with said first valve seat when said valve stem is moved so that said valve stem gate abuts said first valve seat; and
a second gate face configured for sealing engagement with said second valve seat when said valve stem is moved so that said valve stem gate abuts said second valve seat; and
an actuator which selectively reciprocates said valve stem gate between the sealing engagement with said first and second valve seats and to any position in said medial valve body portion disposed therebetween;
wherein said valve stem gate has an outer diameter and wherein said medial valve body portion has an inside diameter between said first and second valve seats; wherein said outside diameter exceeds said inside diameter such that said valve stem gate does not scrape said medial valve body portion during reciprocation of said valve stem.

12. The three-way dual seat valve of claim 11, wherein said actuator comprises an electro-magnetic actuator.

13. The three-way dual seat valve of claim 11, further comprising,
a first fitting fluidically connected to said medial valve body portion;
a second fitting fluidically connected to said first distal valve body portion; and
a third fitting fluidically connected to said second distal valve body portion.

14. The three-way dual seat valve of claim 13, further comprising a fluid flow system connected to said first, second and third fittings, wherein the fluid flow system has a hydraulic pressure and wherein said first fitting is an inlet of the valve body in relation to the fluid flow system, and second and third fittings are outlets of the valve body in relation to the fluid flow system; and wherein:
when said first gate face sealingly engages said first valve seat the hydraulic pressure assists the sealing therebetween; and
when said second gate face sealingly engages said second valve seat the hydraulic pressure assists the sealing therebetween.

15. The three-way dual seat valve of claim 13, wherein the hydraulic pressure causes debris disposed at either of said first and second valve seats to be flushed away as said valve stem gate is moved out of sealing engagement respectively therewith.

16. The three-way dual seat valve of claim 13, further comprising a valve stem guide connected with said first distal valve body portion and guidingly interfaced with said valve stem, wherein said valve stem guide has a fluid flow passage therethrough between said medial valve body portion and said second fitting.

17. The three-way dual seat valve of claim 16, wherein said medial valve body portion, said first distal valve body portion and said second distal valve body portion are cross-sectionally sized with respect to cross-sectional sizing of said first, second and third fittings, and said fluid flow passage of said valve stem guide is cross-sectionally sized with respect to cross-sectional sizing of said second fitting such that a high coefficient of fluid flow is provided.

18. The three-way dual seat valve of claim 11, wherein a valve seal is disposed on at least one of: a) said first and second gate faces, and b) said first and second valve seats.
